(19) United States
(12) Patent Application Publication
(10) Pub. No.: US 2022/0358223 A1
(43) Pub. Date: Nov. 10, 2022

(54) APPARATUS AND METHOD FOR OBTAINING VULNERABLE TRANSACTION SEQUENCE IN SMART CONTRACT

(71) Applicant: Korea University Research and Business Foundation, (US)

(72) Inventors: Hakjoo OH, Seoul (KR); Sunbeom SO, Seoul (KR); Seongjoon HONG, Seoul (KR)

(73) Assignee: Korea University Research and Business Foundation, Seoul (KR)

(21) Appl. No.: 17/602,372

(22) PCT Filed: Apr. 6, 2021
(86) PCT No.: PCT/KR2021/004271

§ 371 Date: Oct. 8, 2021

(30) Foreign Application Priority Data
Nov. 13, 2020 (KR) 10-2020-0151899

(51) Int. Cl. G06F 21/57; G06Q 10/04

(52) U.S. Cl. CPC G06F 21/577; G06Q 10/04

(57) ABSTRACT

Provided is an apparatus and method for obtaining a vulnerable transaction sequence. A vulnerable transaction sequence obtaining apparatus may include a storage configured to transitorily or non-transitorily store at least one program; and a processor configured to receive the at least one program, to select a vulnerable transaction sequence candidate in the at least one program using a cost function, to obtain a verification condition by performing symbolic execution over the transaction sequence candidate, and to check whether the verification condition is satisfiable when the vulnerable transaction sequence is unfound as a verification result about the verification condition, and to determine the vulnerable transaction sequence candidate as the vulnerable transaction sequence when the verification condition is satisfiable.

### TECHNICAL FIELD

The present invention relates to an apparatus and method for obtaining a vulnerable transaction sequence in a program.

### RELATED ART

A smart contract (, which may be expressed as an intelligent contract and the like,) refers to a digital contract written using a predetermined programming language and refers to software configured to automatically conclude a transaction between transaction parties when the transaction meets a predetermined condition. In the case of using the smart contract, a contract may be automatically established depending on whether the condition is met and distributed data storage technology, such as blockchain, is used. Therefore, a third party for reliability of the contract, such as a broker and a notary, is not required and time and cost may be significantly saved compared to a conventional typical contract accordingly. The smart contract technology is attracting attention in various fields, for example, financial and distribution fields. However, since such a smart contract has a close relationship with rights and proprieties of an individual or a company according to conclusion of the contract, whether a vulnerability is present in the smart contract is very important. If an unknown vulnerability (e.g., an integer overflow/underflow) is present in the smart contract and is maliciously used by a third party, it may cause a great property damage to the individual or the company. In particular, once the smart contract is deployed, it is almost impossible to modify specific contents (code) thereof. Therefore, to prevent a problem from being caused by an unknown vulnerability or an unknown bug, there is a need to check, verify, and fix the vulnerability in the smart contract before the deployment. Due to the aforementioned reasons, a code audit for the smart contract is further strictly and carefully performed rather than a code audit for the existing other programs. However, due to complexity of a program code, it is not a simple issue to detect a vulnerability. In particular, when a human manually verifies a vulnerability or a bug, a mistake of missing presence of a vulnerability or a bug in the smart contract frequently occurs despite a large amount of time and cost used.

### DETAILED DESCRIPTION

### Object

The present invention provides an apparatus and method for obtaining a vulnerable transaction sequence in a program that may automatically detect, obtain, validate, or check a vulnerability in a smart contract within a short period of time. The present invention is a work supported by “(SW STAR LAB) Research on Highly-Practical Automated Software Repair” (No. 2020-0-01337), “Development of Automated Vulnerability Discovery Technologies for Blockchain Platform Security” (No. 2019-0-01697), and “Formal Specification of Smart Contract” (2019-0-00099) of Ministry of Science and ICT (MSIT) and Institute of Information & Communications Technology Planning & Evaluation (IITP).

### Solution

To address the aforementioned issues, provided is an apparatus and method for obtaining a vulnerable transaction sequence in a program.

A vulnerable transaction sequence obtaining method may include selecting a vulnerable transaction sequence candidate in at least one program using a cost function; obtaining a verification condition by performing symbolic execution over the transaction sequence candidate; and checking whether the verification condition is satisfiable when the vulnerable transaction sequence is unfound as a verification result about the verification condition, and determining the vulnerable transaction sequence candidate as the vulnerable transaction sequence when the verification condition is satisfiable.

A vulnerable transaction sequence obtaining apparatus may include a storage configured to transitorily or non-transitorily store at least one program; and a processor configured to receive the at least one program, to select a vulnerable transaction sequence candidate in the at least one program using a cost function, to obtain a verification condition by performing symbolic execution over the transaction sequence candidate, and to check whether the verification condition is satisfiable when the vulnerable transaction sequence is unfound as a verification result about the verification condition, and to determine the vulnerable transaction sequence candidate as the vulnerable transaction sequence when the verification condition is satisfiable.

### Effect

According to the aforementioned apparatus and method for obtaining a vulnerable transaction sequence in a program, it is possible to conveniently, accurately, and also quickly, detect, diagnose, validate, or check at least one vulnerability, for example, vulnerability that may occur along an execution path, such as a transaction sequence, from a program such as a smart contract.

According to the aforementioned apparatus and method for obtaining a vulnerable transaction sequence in a program, it is possible to further reinforce security of a program such as a smart contract and to improve stability of an industrial environment (e.g., a Blockchain ecosystem) using the same accordingly.

According to the aforementioned apparatus and method for obtaining a vulnerable transaction sequence in a program, it is possible to simply detect a vulnerable location, and also to verify whether the detected vulnerability can be indeed triggered or to identify a transaction sequence (an execution path) through which the detected vulnerability may occur.

According to the aforementioned apparatus and method for obtaining a vulnerable transaction sequence in a program, it is possible to detect a large number of vulnerable transaction sequences from a program within a short period of time by effectively biasing a search space to preferentially search for an execution path that is relatively highly likely to reveal a vulnerability.

According to the aforementioned apparatus and method for obtaining a vulnerable transaction sequence in a program, it is possible to effectively reduce a time for a security audit of a smart contract and to appropriately save a development and deployment cost according thereto in terms of developing and deploying the smart contract.

According to the aforementioned apparatus and method for obtaining a vulnerable transaction sequence in a program, it is possible to reduce a risk burden on a human mistake that may occur in a security inspection.

### BRIEF DESCRIPTION OF DRAWINGS

Detailed description related to each drawing is provided to further sufficiently understand drawings cited in the detailed description of the present invention:

FIG. 1 is a block diagram illustrating a vulnerable transaction sequence obtaining apparatus according to an example embodiment;

FIG. 2 illustrates a program according to an example embodiment written in Solidity;

FIG. 3 is a block diagram to describe an operation of a vulnerability processing according to an example embodiment;

FIG. 4 illustrates an example of an algorithm to describe an operation of a vulnerability processing according to an example embodiment;

FIG. 5 is a block diagram to describe an operation of a language model processing according to an example embodiment;

FIG. 6 is a flowchart illustrating a vulnerable transaction sequence obtaining method according to an example embodiment; and

FIG. 7 is a flowchart illustrating a process of performing learning based on a language model according to an example embodiment.

### MODE

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Example embodiments of the present invention are described with reference to the accompanying drawings. However, the scope of the claims is not limited to or restricted by the example embodiments. Like reference numerals proposed in the respective drawings refer to like elements.

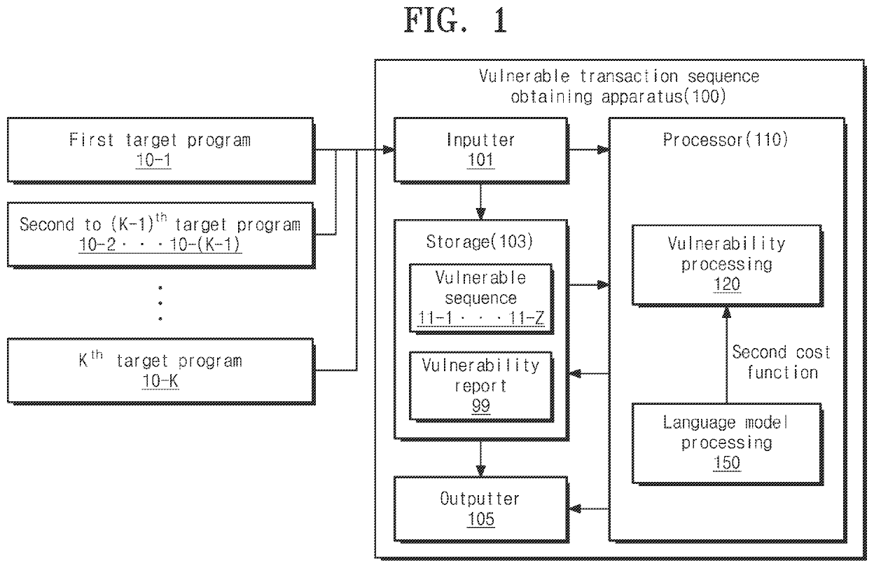

Hereinafter, example embodiments of a vulnerable transaction sequence obtaining apparatus are described with reference to FIGS. 1 to 5.

FIG. 1 is a block diagram illustrating a vulnerable transaction sequence obtaining apparatus according to an example embodiment.

Referring to FIG. 1, a vulnerable transaction sequence obtaining apparatus 100 may include an inputter 101, a storage 103, an outputter 105, and a processor 110.

The inputter 101 may receive at least one program (hereinafter, also referred to as a target program) (10-1 to 10-K) configured to obtain a vulnerable transaction sequence from a designer or a user (hereinafter, a user) of the vulnerable transaction sequence obtaining apparatus 100 or an external other apparatus. The inputter 101 may receive at least one target program (10-1 to 10-K) according to a direct manipulation from the user on a keyboard, may receive the at least one target program (10-1 to 10-K) through an external memory device (a secure digital (SD) card, a universal serial bus memory device, an external hard disk device, etc.), or may receive the at least one target program (10-1 to 10-K) through a wired/wireless communication network. Depending on example embodiments, the inputter 101 may include a keyboard, a mouse, a tablet, a touchscreen, a touch pad, a scanner, an image capturing module, a microphone, a trackball, and/or a trackpad. Also, depending on example embodiments, the inputter 101 may include a data input/output (I/O) terminal configured to receive data from an external device (a memory device, etc.) or a communication module (e.g., a local area network (LAN) card, a short-distance communication module, a mobile communication module, etc.) connected with the external device through a wired/wireless communication network.

The storage 103 may transitorily or non-transitorily store information required for an operation of the vulnerable transaction sequence obtaining apparatus 100. For example, the storage 103 may be configured to store the at least one target program (10-1 to 10-K) input through the inputter 101 and/or to store at least one of at least one vulnerable transaction sequence (11-1 to 11-Z) and a vulnerability report 99 obtained by the processor 110. Also, the storage 103 may store a cost function (hereinafter, a second cost function) obtained by a language model processing 150. In addition, the storage 103 may store a variety of information required. Also, the storage 103 may store at least one application required for an operation of the vulnerable transaction sequence obtaining apparatus 100, for example, the processor 110. Here, the application stored in the storage 103 may be implemented by combining, alone or in combination, at least one variable, instruction, data, library, and/or function for implementing each operation of a vulnerability processing 120 of the processor 110, and may be generated based on at least one of various conventionally known programming languages such as C, C++, C#, Java, Python, Solidity, .NET, and/or Visual Basic. The application stored in the storage 103 may be pre-generated directly by the designer depending on example embodiments and/or may be obtained or updated through an electronic software distribution network accessible through a wired or wireless communication network. The storage 103 may transfer necessary information or instruction to the processor 110 according to a call of the processor 110. Based thereon, the processor 110 may perform an operation for obtaining a vulnerable transaction sequence. According to an example embodiment, the storage 103 may include at least one of a main memory device and an auxiliary memory device. The main memory device may be implemented using a semiconductor storage medium, such as a read only memory (ROM) and/or a random access memory (RAM), and the auxiliary memory device may be implemented using a flash memory device, an SD card, a solid state drive (SSD), a hard disc drive (HDD), a magnetic drum, optical media such as a compact disc (CD), a DVD, and a laser disk, a magnetic tape, a magneto-optical disk, and/or at least one storage medium capable of permanently or semi-permanently storing data such as a floppy disk.

The outputter 105 may output at least one piece of data to an outside in a visual or auditory manner. For example, the outputter 105 may output, to the outside, the vulnerable transaction sequences (11-1 to 11-Z) or the vulnerability report 99 obtained by the processor 110 and/or stored in the storage 103. Depending on example embodiments, the outputter 105 may be provided in an integrated type with the vulnerable transaction sequence obtaining apparatus 100 or may be provided to be physically separable therefrom. The outputter 105 may be implemented using, for example, a display, a printer device, a speaker device, an image output terminal, a data I/O terminal, and/or a communication module. However, it is provided as an example only.

The processor 110 may simultaneously or sequentially perform arithmetic operations, determination, processing, and/or control operations associated with an operation of the vulnerable transaction sequence obtaining apparatus 100. To this end, the processor 110 may execute the application stored in the storage 103. The processor 110 may include, for example, a central processing unit (CPU), a micro controller unit (MCU), a micro processor (Micom), an application processor (AP), an electronic controlling unit (ECU), and/or other electronic devices capable of generating various types of operation processing and control signals. The devices may be implemented using, for example, a single or at least two semiconductor chips.

According to an example embodiment, the processor 110 may obtain at least one target program (10-1 to 10-K) from the inputter 101 or the storage 103, may obtain at least one transaction sequence (hereinafter, vulnerable transaction sequence) (11-1 to 11-Z) having at least one vulnerability from at least one of the obtained at least one target program (10-1 to 10-K). Here, the at least one transaction sequence refers to a series of transactions (t₀, t₁, . . . , tₙ ∈T*) from a first transaction to an n^{th} transaction, and a transaction t∈T may be defined to be a 4-tuple of (id, f, x, a) in which an identifier (id) for identifying a transaction is added to a function path. The function path refers to a sequence of statements (e.g., atomic statements) from the entry to the exit of the function and may be given in a form of (f, x, a) for a function f(x)SEF (hereinafter, a set of all function paths present in the target programs (10-1 to 10-K) is denoted P). In the case of obtaining at least one vulnerable transaction sequence from the target programs (10-1 to 10-K), the processor 110 may obtain a single or a plurality of vulnerable transaction sequences (11-1 to 11-Z) from one of the target programs (10-1 to 10-K) and may obtain a single or the plurality of vulnerable transaction sequences (11-1 to 11-Z) from the plurality of target programs (10-1 to 10-K). According to an example embodiment, a vulnerable transaction sequence obtained by the processor 110 may be a transaction sequence that contains an assertion statement that may violate a safety condition among statements (e.g., atomic statements) executed by the last transaction tₙ.

According to an example embodiment, the processor 110 may obtain at least one vulnerable transaction sequence (11-1 to 11-Z) by performing symbolic execution for each of at least one target program (10-1 to 10-K). Also, depending on example embodiments, the processor 110 may obtain vulnerable transaction sequence (11-1 to 11-Z) from at least one target program (10-1 to 10-K) by further using a language model. In the case of using the language model, the processor 110 may preferentially perform symbolic execution and search of the vulnerable transaction sequences (11-1 to 11-Z) from vulnerable transaction sequence candidate(s) highly likely to reveal a vulnerability. Therefore, a search space of the symbolic execution may be further effectively biased.

Referring to FIG. 1, according to an example embodiment, the processor 110 may include the vulnerability processing 120 configured to search for a single or the plurality of vulnerable transaction sequences (11-1 to 11-Z) from the target programs (10-1 to 10-K) and the language model processing 150 configured to provide an appropriate second cost function to the vulnerability processing 120 using the language model. Each of the vulnerability processing 120 and the language model processing 150 may be logically distinct or may be physically distinct. In the case of physical distinction, each of the vulnerability processing 120 and the language model processing 150 may be implemented using at least one semiconductor chip that is physically separated and electrically connected. Depending on example embodiments, the language model processing 150 may be omitted. When the language model processing 150 is absent, the processor 110 may obtain at least one vulnerable transaction sequence (11-1 to 11-Z) from at least one target program (10-1 to 10-K) using another cost function (hereinafter, a first cost function) without using the second cost function. Alternatively, the processor 110 may obtain at least one vulnerable transaction sequence (11-1 to 11-Z) using the second cost function obtained by another information processing device (not shown). Here, the second cost function obtained by the other information processing device may be transferred to the processor 110 through the inputter 101 or the storage 130. Further description related to an operation and a function of the processor 110 is made below.

The aforementioned vulnerable transaction sequence obtaining apparatus 100 may be implemented using at least one information processing device capable of performing information obtainment and operation processing. For example, the vulnerable transaction sequence obtaining apparatus 100 may include a desktop computer, a laptop computer, a server-dedicated computer device, a smartphone, a tablet PC, a smartwatch, a head mounted display (HMD) device, a navigation device, a portable game player, a personal digital assistant (PDA), a digital television (TV), a set-top box, home appliances (a refrigerator, a robot cleaner, etc.), an artificial intelligence (AI) sound reproduction device (AI speaker), a vehicle, a manned or unmanned aerial object, a robot, an industrial machine, and/or an information processing device capable of inputting and correcting a symbol. However, without being limited thereto, the vulnerable transaction sequence obtaining apparatus 100 may include various types of electronic devices considerable by the designer. Also, depending on example embodiments, the vulnerable transaction sequence obtaining apparatus 100 may be implemented using at least two information processing devices.

At least one of first to k^{th} target programs 10-1 to 10-K may be transferred to the processor 110 through the inputter 101, or may be transitorily or non-transitorily stored in the storage 103 and then transferred to the processor 110 and the processor 110 may check and review whether a vulnerability is present. In this case, depending on example embodiments, at least one of the first to the k^{th} target programs 10-1 to 10-K may be simultaneously or sequentially input through the inputter 101 or stored in the storage 103.

According to an example embodiment, at least one of the first to the k^{th} target programs 10-1 to 10-K may include a smart contract. That is, the processor 110 may analyze the smart contract and may detect a vulnerability, for example, a vulnerable transaction sequence from the smart contract.

All of the first to the k^{th} target programs 10-1 to 10-K may be coded using the same type of programming language. Alternatively, a portion thereof may be coded using a programming language different from that of another portion thereof. Alternatively, all of the first to the k^{h} target programs 10-1 to 10-K may be coded using different types of programming languages. Here, the programming language may include at least one of various conventionally known programming languages, such as, for example, C, C++, C#, Java, Python, Solidity, and/or Visual Basic. For example, when the target program (10-1 to 10-K) is a smart contract that operates in Blockchain such as Ethereum, the target program (10-1 to 10-K) may be written in Solidity.

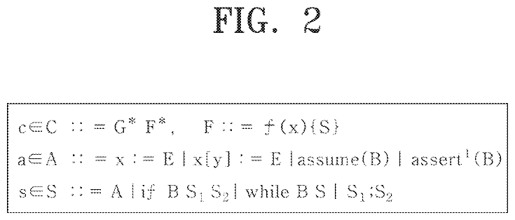

FIG. 2 illustrates a program according to an example embodiment written in Solidity. In FIG. 2, E denotes a usual arithmetic expression (e.g., a+b) and B denotes a Boolean expression (e.g., a≥b).

When the target program (10-1 to 10-K) is a smart contract written based on Solidity, the target program (10-1 to 10-K) may be expressed in simplified Solidity of FIG. 2. That is, although a program code is complexly written based on the Solidity, the target program (10-1 to 10-K) may be briefly expressed using simplified Solidity in FIG. 2 through a predetermined preprocessing process. In this case, referring to FIG. 2, a smart contract (c) may include global state variable declarations (G*) and function definitions (F*). In this case, as illustrated in a first line (line 1) of FIG. 2, each function (F) may be defined by including a function name (f), at least one formal parameter (χ) and/or at least one statement (S). As illustrated in a third line (line 3) of FIG. 2, the statement (S) may include at least one of an atomic statement (A), an if-statement (if B Si S₂), a while-loop statement (while B S) and a sequence of at least one statement (S₁;S₂). Here, as illustrated in a second line (line 2) of FIG. 2, an atomic statement (a) may include an assignment to a variable (χ:=E), an assignment to an array element (χ[y]:=E), an assume statement (assume(B)), and/or an assert statement (assert¹(B)). The assignment to a variable (χ:=E) may assign a variable, the assignment to an array element (χ[y]:=E) may assign a value for array variable elements or a value for mapping type variable elements in the Solidity. The assume statement (assume(B)) may construct, as a single statement, an if-expression (e.g., B in the if-statement or while-loop) that determines an execution path of a program. The assert statement (assert¹(B)) is used to perform determination on a predetermined target (B) and to determine true or false of the target (B). Accordingly, the assert statement (assert¹(B)) may be used to express a condition about a property desired to be analyzed (e.g., a safety condition) or to determine whether the condition (safety condition) is violated. Here, the property to be analyzed may include a safety about a vulnerability (e.g., an integer overflow or an integer underflow, a division-by-zero vulnerability, etc.) of the target program (10-1 to 10-K), that is, the smart contract (c). If a condition in the assert statement (assert¹(B)) is violated and the condition is calculated as false, it means that a vulnerability is present in the target program (10-1 to 10-K). The designer may express such safety condition by inserting the assert statement (assert¹(B)) in the target program (10-1 to 10-K). Depending on example embodiments, the assert statement (assert¹(B)) may be automatically inserted in the target program (10-1 to 10-K) without a manipulation of the designer. If necessary, every assert statement (assert¹(B)) may be annotated with a unique label 1, which serves as an identifier for each of assert statements.

Hereinafter, an example embodiment of an operation of the vulnerability processing 120 of the processor 110 is described. Here, a vulnerability detecting and obtaining operation is described using the first target program 10-1 as an example. However, even with respect to the second target program 10-2 to the K^{th} target program 10-K, the vulnerability processing 120 may detect and obtain a vulnerability in the same or partially modified manner as described below.

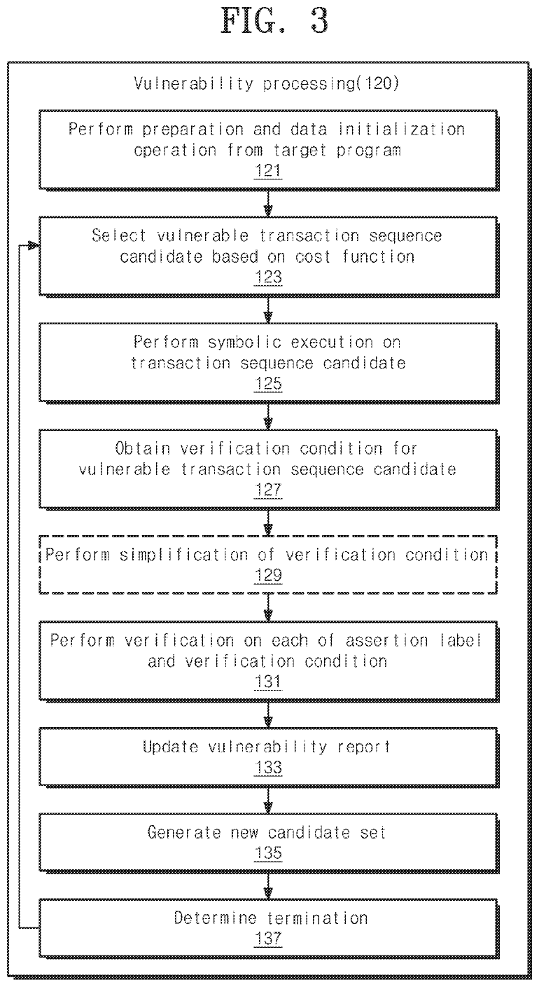

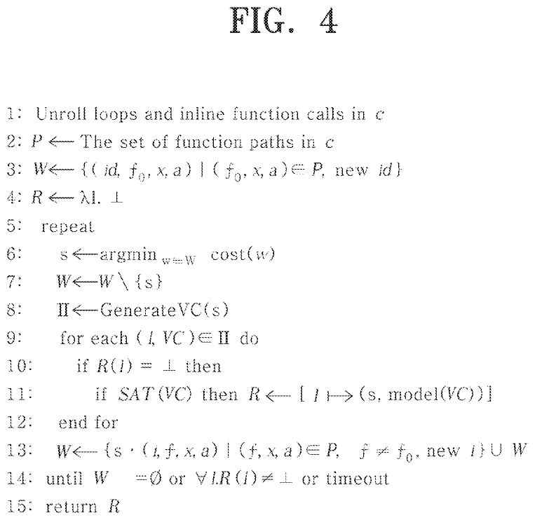

FIG. 3 is a block diagram to describe an operation of a vulnerability processing according to an example embodiment, and FIG. 4 illustrates an example of an algorithm to describe an operation of a vulnerability processing according to an example embodiment. The algorithm of FIG. 4 may be processed by the processor 110.

Referring to FIG. 3, when receiving the first target program 10-1, the vulnerability processing 120 may perform a preparation operation and an initialization operation of various data to detect at least one vulnerability (e.g., a vulnerable transaction sequence) from the first target program 10-1 (121). Here, the preparation operation may include a process of decomposing the first target program 10-1 and deforming the same to be an appropriate form for processing.

In detail, for example, the vulnerability processing 120 may perform the preparation operation and the initialization operation as illustrated in line 1 to line 4 of a program code of FIG. 4. For example, the vulnerability processing 120 may modify the target program 10-1 by unrolling each loop (e.g., while-loop, etc.) and/or inlining each of functions to be called into its call site in the target program 10-1 (line 1). Here, unrolling of loops may be performed up to a predetermined number of times (m, m denotes a natural number) and inlining of functions may be performed up to a predetermined number of times (the maximum call depth of nested function calls, n, n denotes a natural number, and n and m may be identical to each other or may differ from each other). By performing unrolling and/or inlining, it is possible for the vulnerability processing 120 to avoid indefinitely listing and analyzing function paths. The vulnerability processing 120 may sequentially collect function paths corresponding to each function present in the target program 10-1 modified by unrolling and/or inlining (line 2). Here, the vulnerability processing 120 may obtain a set (P) of function paths by collecting a number of function paths equal to a predetermined number (o) or less than the predetermined number (o). Depending on circumstances, a single function path or at least two function paths may be obtained from a single function. Also, with, before, or after the modification of the target program 10-1 and the function path obtaining process, the vulnerability processing 120 may initialize a set (W, hereinafter, a workset) for a vulnerable transaction sequence candidate set (line 3). In detail, the vulnerability processing 120 may initialize the workset W using at least one initial transaction to derived from a constructor function (a function that is called only once at deployment time of the target program 10-1 and not executed thereafter). In addition therewith, the vulnerability processing 120 may also initialize the vulnerability report 99 (R: L→T*×Model) in which a vulnerable transaction sequence is to be recorded. For example, the vulnerability processing 120 may initialize the vulnerability report 99 to λl.⊥ by inputting λl.⊥ to the vulnerability report 99 (line 4). Here, λl.⊥ represents that all assertion labels l are mapped with ⊥, using a lambda notation. In detail, it represents that no transaction sequence, which may violate a safety condition in the assert statement, is found yet for any assertions.

As described above, when the preparation operation and the initialization operation are terminated, the vulnerability processing 120 may select a vulnerable transaction sequence candidate (123). In this case, the vulnerability processing 120 may select, from the workset W, a vulnerable transaction sequence candidate (s=t₀, t₁, . . . , tₙ) that minimizes cost based on a predetermined cost function (cost(w)) (hereinafter, a first cost function) (i.e., argmin_{w∈W} cost(w)) (line 6). The selected vulnerable transaction sequence candidate(s) may be simultaneously or sequentially removed from the workset (line 7). According to an example embodiment, the first cost function may be defined as cost(s)=n to preferentially search for candidates with relatively short lengths. Depending on example embodiments, the vulnerability processing 120 may select, from the workset W, the vulnerable transaction sequence candidate(s) that minimizes cost by using a second cost function instead of using the first cost function. The second cost function may be transferred from the language model processing 150 to the vulnerability processing 120. The second cost function is described below.

The vulnerability processing 120 may perform symbolic execution on the selected transaction sequence candidate(s) (125) and may obtain a verification condition (VC) corresponding to a result of the symbolic execution (127) (line 8). The verification condition may include a first-order logic formula to be verified to check whether the vulnerable transaction sequence candidate(s) are actually vulnerable transaction sequences for assert statements. As a result of performing the symbolic execution, a separate set (Π) that includes an assertion label (1) and the verification condition (VC) corresponding thereto may be obtained together.

According to an example embodiment, the vulnerability processing 120 may perform symbolic execution using a predetermined function (hereinafter, a verification condition generating function, GenerateVC(s) of FIG. 4). The verification condition generating function (Generate (t₀, t₁, . . . , tₙ)) may be designed to output a predetermined set Π based on pairs of an assertion label 1 and a verification condition associated therewith for the transaction sequence (t₀, t₁, . . . , tₙ). Here, according to an example embodiment, the predetermined set (Π) may be obtained using a symbolic executor T′ for a transaction obtained by modifying a symbolic executor T for a transaction. For example, the following Equation 1 may be used to obtain the predetermined set Π.

(−,Π)=T′(tₙ)o . . . oT′(t₀)(∧_{g∈G}init(g),θ) [Equation 1

In Equation 1, init(g) denotes a function that allocates a default value suitable for each type of a variable to a global state variable g∈G. The symbolic executor T′ for the transaction may be defined as the following Equation 2.

$${T}^{′} ( {t}_{i} ) ( {ϕ}^{″} , {\prod }^{″} ) = \{ \begin{matrix}( {ϕ}^{′} , {\prod }^{′} ) & if i = n \\ ( {ϕ}^{′} , ∅ ) & otherwise\end{matrix} \qquad [ Equation 2 ]$$

In Equation 2, formula φ′ and set Π′ may be obtained from the symbolic execution for the transaction. That is, (ϕ′,Π′)=T(tᵢ)(ϕ″,Π″) is established. In this case, when an index value is n (i.e., the last transaction given a transaction sequence), the set Π′ of pairs of the assertion label 1 and verification condition may be obtained. That is, the verification condition may be obtained from the last transaction tₙ only. In more detail, for an i^{th} transaction (tᵢ, i<n), transactions (tⱼ, j>i) after the i^{th} transaction do not affect whether a safety condition is disproved in tᵢ. Therefore, although the verification condition is obtained from the last transaction tₙ only, there is no issue in detecting a vulnerable transaction sequence from the target program 10-1.

A symbolic executor for a transaction (T:T→FOL×2^{L×FOL}→FOL×2^{L×FOL} where L denotes a set of all the assertion labels 1, FOL denotes a set of formulas that may be expressed as the first-order logic, T on the right of ‘:’ denotes a set of transactions) may be given as the following Equation 3:

T(i,f,χ,(a₁, . . . ,aₙ))(ϕ,Π)=(RENAMEL(ϕ′,i),{(l,RENAMEL(F,i)|(l,F)∈Π′}) [Equation 3

In Equation 3, φ′ and Π′ may be obtained using a symbolic executor, that is, a postcondition transformer (sp) for the atomic statement as shown in the following Equation 4.

(ϕ′,Π′)=sp(aₙ)o . . . osp(a₁)(ϕ∧χ^{e}=χ∧ϕ,Π) [Equation 4]

In Equation 4, χ^{e} of χ^{e}=χ∧ϕ denotes a variable that represents a state at a function entry of a formal parameter and ϕ denotes an additional constraint for generating an appropriate transaction call element value and may be given as a conjunctive formula. Depending on example embodiments, ϕ may include a Solidity-specific additional constraint. For example, ϕ may include a possible atomic formula, such as msg.sender≠0. The postcondition transformer (sp: a→FOL×2^{L×FOL}→FOL×2^{L×FOL}) of Equation 4 refers to a transformer that may transform an execution meaning about the atomic statement a∈A to the first-order logic formula. The postcondition transformer (sp) may be defined as, for example, the following Equation 5, however, is not limited thereto. The postcondition transformer (sp) may be defined using various methods according to a selection of the designer.

sp(χ:=e)(ϕ,Π)=(ϕ[χ′/χ]∧(χ=e[χ′/χ])°,Π

sp(χ[y]:=e)(ϕ,Π)=(ϕ[χ′/χ]∧(χ=χ′(y<e[χ′/χ])°,Π)

sp(assume(e))(ϕ,Π)=(ϕ∧e^{⋅},Π)

sp(assert′(e))(ϕ,Π)=(ϕ,{(l,ϕ∧−e)}∪Π)

In Equation 5, ϕ[χ′/χ] denotes a formula ϕ in which a variable χ is replaced by a new variable χ′ and e[χ′/χ] denotes an expression e in which the variable χ is replaced by the new variable χ′. χ′(y<e[χ′/χ]) of a second line (line 2) of Equation 5 denotes an array in which a value present at an index y is replaced by e[χ′/χ] for the variable χ that is an array type or a mapping type. Referring to Equation 5, depending on example embodiments, given a precondition and a set (Π) of pairs of labels-verification conditions accumulated so far, the postcondition transformer (sp) may transform the precondition to a postcondition based on an execution meaning of each atomic statement (a) (e.g., an assignment to a variable, an assignment to an array element, and/or an assume statement) excluding an assert statement (first to third lines (line 1 to line 3) of Equation 5). Also, in the case of an assert statement, the postcondition transformer (sp) may accumulate a new assertion label-verification condition pair into a set of assertion label-verification condition pairs (Π) (fourth line (line 4) of Equation 5). In detail, the postcondition transformer (sp) for the assert statement may be defined to combine ϕ denoting a current state of the program (10-1 to 10-K) and −e that is a negation of a safety condition in the assert statement using an operator ∧, to match the same with a corresponding assertion label 1, and to add the same to the set of label (1) and verification condition (VC) pairs. According to an example embodiment, referring to Equation 5, in the postcondition transformer (sp), a symbol º may be further added to a formula that is added to the assignment to a variable and a symbol ⋅ may be further added to a formula that is added to the assume statement. Such symbols are introduced to simplify constraints by differentiating equality constraints from the assignment to a variable and the assume statement. It is further described below.

Meanwhile, in the symbolic executor T for the transaction expressed as the above Equation 3, RenameL refers to a function for differentiating local variables with the same name in different transactions and, more particularly, differentiates the local variables by renaming predetermined variable(s) in a given formula using a transaction identifier. In this case, RenameL may be provided to not perform renaming for global variable (variable that is permanently present over the entire transactions starting from the deployment time, which differs from a local variable) and/or primed global variable(s). In detail, for example, if formula a′=0 ∧b=1 ∧c′=2 is given for a transaction identifier j, a is an only global state variable, and the aforementioned formula is input, RenameL may output a result of a′=0 ∧bⱼ=1 ∧c′ⱼ=2. That is, a local variable b and a primed variable c′ of a local variable c are renamed into variables bⱼ and c′ⱼ each annotated with the transaction identifier j. Here, a′ is not renamed since it is a primed variable of the global state variable.

As described above, if at least one verification condition is obtained as a result of performing symbol execution using a predetermined verification condition generating function, the vulnerability processing 120 may perform verification on each of at least one assertion label (1) and verification condition (VC) corresponding to the assertion label (1) as illustrated in FIGS. 3 and 4 (131) (lines 9 to 12 of FIG. 4). Verification on the assertion label (1) and the verification condition (VC) may be sequentially performed, or may be performed in arbitrary order.

If a vulnerable transaction sequence capable of violating the safety condition is unfound for the assert statement of the label 1 (i.e., the assertion label 1 of the vulnerability report 99 (R) is mapped to 1 (line 10 of FIG. 4), the satisfiability of the given verification condition may be checked (line 11 of FIG. 4). According to an example embodiment, at least one analysis program may be used to check the satisfiability of the given verification condition. Here, the at least one analysis program may include, for example, a satisfiability modulo theories (SMT) solver, such as Z3. Depending on example embodiments, the SMT solver may be included in an application executed on the processor 110, or may not be included in the application and may be called from an outside in response to execution of the application. Also, the SMT solver may be stored in the storage 103 included in the vulnerable transaction sequence obtaining apparatus 100, and may be provided to the vulnerability processing 120 in response to call from the vulnerability processing 120, and/or may be received from an external apparatus (not shown) through the inputter 101, such as a communication module, in response to call from the vulnerability processing 120 and may be provided to the vulnerability processing 120.

That the verification condition is satisfiable may represent that a case of revealing a vulnerability is present in the vulnerable transaction sequence candidate(s). That is, it represents that a current target to be analyzed, the vulnerable transaction sequence candidate(s), is determined as a vulnerable transaction sequence. If the verification condition is satisfiable, the vulnerability report 99 (R) may be updated (133) (line 11 of FIG. 4). For example, if the verification condition is satisfiable, updating of the vulnerability report 99 (R) may be performed by mapping the assertion label 1 to the vulnerable transaction sequence candidate(s) (i.e., at least one of vulnerable transaction sequences (11-1 to 11-Z)) and a satisfying model (model(VC) for the verification condition). Here, the satisfying model (model(VC)) may include actual parameter value information about a formal parameter of each transaction as a solution that satisfies the verification condition. Therefore, if necessary, a parameter value required for each transaction call may be obtained based thereon. Also, if necessary, the vulnerable transaction sequence candidate(s) determined to be vulnerable may be stored in the storage 103 or may be output through the outputter 105 as the vulnerable transaction sequences (11-1 to 11-Z). Storing or outputting of the vulnerable transaction sequences (11-1 to 11-Z) and updating of the vulnerability report 99 (R) may be performed simultaneously or sequentially.

On the contrary, if a vulnerable transaction sequence, which may violate the safety condition in the assert statement of the label 1 is found (i.e., R(1)#-1), determining whether the verification condition is satisfiable (line 11 of FIG. 4) is not performed.

A new vulnerable transaction sequence candidate set may be sequentially generated and added to the workset W in operation (135) (line 13 of FIG. 4). In detail, for example, the new vulnerable transaction sequence candidate set may be generated by adding a transaction for at least one vulnerable transaction sequence candidate set (s) that is a current target to be analyzed and the generated new vulnerable transaction sequence candidate set may be added to the workset W.

The aforementioned cost function-based vulnerable transaction sequence candidate selecting process to the new vulnerable transaction sequence candidate set generating process (123 to 135) (lines 5 to 14 of FIG. 4) may be repeated at least once and may be continuously repeated until a predetermined setting is met. For example, the aforementioned process (123 to 135) (lines 5 to 14 of FIG. 4) may be designed to be terminated if no vulnerable transaction sequence candidate set (s) is present in the workset W (W=θ), if a vulnerable transaction sequence for assert statements is found (∀l. R(l)≠⊥), and/or if the predetermined time expires (137) (line 14 of FIG. 14). If the aforementioned process is terminated, the vulnerability processing 120 may output the obtained vulnerability report 99 (R) and may transfer the same to at least one of the storage 103 and the outputter 105.

According to an example embodiment, the vulnerability processing 120 may further perform simplification of the verification condition (129) before performing the verification on each of the assertion label and verification the condition (131). In detail, if a verification condition formula is complex when determining the satisfiability of the verification condition, a large amount of resources or a long processing time may be required. Therefore, there is a need to simplify the verification condition before performing the verification to prevent the large amount of resources or the long-processing time from being used.

For example, simplification of the verification condition may be performed based on a predetermined simplification rule. For example, the verification condition may be simplified using a method of replacing a logical formula in which true or false, such as a≤a, is evident by a true value and a false value.

As another example, simplification of the verification condition may be performed by excluding logical formulas irrelevant to verification from the verification condition. For example, the verification condition may be simplified by excluding, from the verification condition, logical formulas irrelevant to safety conditions that are direct verification targets or conditions (path conditions) derived from assume statements. For example, suppose a verification condition (χ=y)°∧(z=10)^{⋅}∧−(y+1≥y) and a safety condition (y+1≥y) are given. In this case, we can know that an atomic formula (χ=Y)° has been generated from an assignment (i.e., χ=Y) and a formula (Z=10)^{⋅} has been generated from an assume statement (assume(Z=10)). That is, considering a symbol º of the formula (χ=Y)°, a value in the formula (χ=Y)° is transferred from y to χ. Therefore, information about χ is unnecessary information to determine whether the safety condition is violated or to pass the assume statement. Therefore, if symbols ⋅ and º are removed after applying the above, the above verification condition (χ=y)°∧(z=10)^{⋅}∧−(y+1≥y) may be simplified to a form of (z=10)∧−(y+1≥y).

As another example, simplification of the verification condition may be performed through quantifier elimination optimization. In detail, if a verification condition ∀i.χ′[i]=0∧χ=χ′(y<10)∧−(χ[y]<10) is given and variables χ and χ′ are mapping type variables, it can be known that y is an only index variable used to access elements of χ and χ′ in the verification condition. Therefore, when information about element(s) unnecessary to determine the satisfiability of χ and χ′ is removed from the verification condition, the given verification condition ∀i.χ′[i]=0∧χ=χ′(y<10)∧−(χ[y]<10) is simplified and replaced by a form of χ′[y]=0∧χ=χ′(y<10)∧−χ[y]<10). When the verification condition is simplified, the vulnerability processing 120 may perform verification on the simplified verification condition. For example, as described above, the vulnerability processing 120 may verify and check the satisfiability of the simplified verification condition by calling an SMT solver and, based thereon, may generate or update the vulnerability report 99.

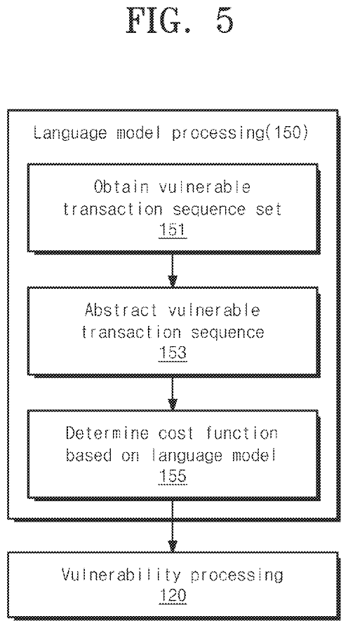

FIG. 5 is a block diagram to describe an operation of a language model processing according to an example embodiment.

The language model processing 150 may obtain a second cost function based on at least one vulnerable transaction sequence (11-1 to 11-Z) input through the inputter 101 and/or obtained depending on an operation result of the vulnerability processing 120 and may transfer the obtained second cost function to the vulnerability processing 120. The vulnerability processing 120 may select the vulnerable transaction sequence candidate based on the second cost function transferred by the language model processing 150 (123 of FIG. 3). Therefore, the vulnerability processing 120 may preferentially select and search for vulnerable transaction sequence candidate(s) highly likely to reveal a vulnerability. A search space of a symbol execution may be effectively biased.

According to an example embodiment, referring to FIG. 5, the language model processing 150 obtains at least one vulnerable transaction sequence set ({T₁, . . . , Tₙ}, (Tᵢ∈T*)) including at least one vulnerable transaction sequence (11-1 to 11-Z) input through the inputter 101 and/or determined by the vulnerability processing 120 (151). The at least one vulnerable transaction sequence (11-1 to 11-Z) may be obtained as the aforementioned operation result of the vulnerability processing 120 for a plurality of target programs, for example, the first target program 10-1 to the K^{th} target program 10-K.

The language model processing 150 may abstract the vulnerable transaction sequence (11-1 to 11-Z) to an appropriate form (153). Abstraction of the vulnerable transaction sequence is performed such that a learned language model may appropriately apply to various types of new programs, transactions, or transaction sequences. According to an example embodiment, the language model processing 150 may obtain an abstracted transaction sequence set (Y) by transforming each vulnerable transaction sequence (11-1 to 11-Z), (Tᵢ=tᵢ⁰ . . . tᵢⁿ) to a corresponding abstracted transaction sequence according to the following Equation 6.

Y={(s)(s)α_{τ}(tᵢ⁰) . . . α_{τ}(tᵢⁿ)(e)(e)∈\hat{T}*[tᵢ=tᵢ⁰. . . tᵢⁿ,i∈[1,m]} [Equation 6]

Here, τ:Type→N(N denotes an integer set) denotes a type frequency table and includes information about a number of times types that appear in the vulnerable transaction sequence set. Here, each type frequency may be obtained by counting type frequencies for global variables that are defined through assignments or used in assume statements within each transaction before abstraction. Using τ, a transformation function (α_{τ}:T→\hat{T}) that transforms each transaction to an abstract form of a transaction (e.g., W∈\hat{T}) may be defined as, for example, the following Equation 7.

$${α}_{τ} ( t ) = \{ \begin{matrix}if t = ( - , {f}_{0} , - , - ) then 〈 i 〉 \\ else 〈 {D}_{τ}^{1} ( t ) , … , {D}_{τ}^{k} ( t ) , {U}_{τ}^{1} ( t ) , … , {U}_{τ}^{k} ( t ) , P ( t ) , E ( t ) , X ( t ) 〉\end{matrix} \qquad [ Equation 7 ]$$

In this case, depending on example embodiments, each word w that is a transformation result of the transformation function (α_{τ}) may include a pseudo-start word<s>, a pseudo-end word<e>, a constructor word<i> for abstracting a constructor function path, and/or a Boolean vector of 2^{k+3} dimension abstracted only top ranking k types from τ. In Equation 7, D_{τ}ⁱ(1≤i≤k) is a predicate that checks whether a global state variable having a top it i^{th} ranked type in τ is defined through assignments. Also, U_{τ}ⁱ(1≤i≤k) is a predicate that checks whether the global state variable having the top i^{th} ranked type in τ is used in the assume statements. P(t) is a predicate that checks whether a transaction-derived function is derived is annotated with a payable keyword. A function having a payable keyword in Solidity has a function capable of receiving cryptocurrency (e.g., ether, etc.) in blockchain. Therefore, in the case of analyzing a program (10-1 to 10-K) that is a smart contract, there is a need to check whether the function having the payable keyword is present. E(t) is a predicate that checks whether a function (e.g., a transfer function) that transfers cryptocurrency is present in a transaction-derived function path. χ(t) is a predicate that checks whether a function (e.g., a selfdestruct function) that destructs a contract is present in the transaction-derived function path. Although Equation 7 is described to include all of the aforementioned predicates, at least one of the predicates may be omitted based on a designer selection and/or another predicate in addition thereto may be further added.

As described above, when the abstracted transaction sequence set (Y) is obtained, a vulnerable transaction sequence candidate search method of the vulnerability processing 120 using a predetermined language model may be determined based on the abstracted transaction sequence set (Y) (155). In detail, the language model processing 150 may determine a cost function (i.e., a second cost function) based on the abstracted transaction sequence set (Y).

The vulnerability processing 120 may select the vulnerable transaction sequence candidate using the second cost function. In this manner, search order of all of the vulnerable transaction sequence candidates may be appropriately modified. In this case, the language model may include a statistical language model (SLM), and more particularly, may include an n-gram language model that uses a predetermined number of words (n words). However, the language model is not limited thereto and the designer may consider and apply various types of language models to determine vulnerable sequence candidate search order.

To determine the second cost function based on the language model (e.g., the n-gram language model), at least one transaction sequence (t₀, t₁, . . . , tₙ) may be transformed to at least one word sequence<s><s>w₀ . . . wₙ. In this case, transformation may be performed using a function α′_{τ}:T→\hat{T} that is represented through the following Equation 8. This function is provided to appropriately transform an unknown word to a known word (w∈V). Here, V(V⊆\hat{T}) is a set (V={Wᵢ|W₁ . . . wₘ∈Y,i∈[1,m]}) of all the abstracted transactions (i.e., known words) present in the abstracted transaction sequence set (Y).

$${α}_{τ}^{′} ( t ) = \{ \begin{matrix}{α}_{τ} ( t ) & if {α}_{τ} ( t ) ∈ V \\ arg {max}_{w ∈ v} similarity ( {α}_{τ} ( t ) , w ) & if {α}_{τ} ( r ) ∉ V\end{matrix} \qquad [ Equation 8 ]$$

Here, a similarity function (similarity(wᵢ, w₂)) refers to a function that computes a similarity between two words wᵢ and w₂, and may be defined as, for example, the following Equation 9.

$$similarity ( 〈 {v}_{1} , … , {v}_{2 k + 3} 〉 , 〈 {v}_{1}^{′} , … , {v}_{2 k + 3}^{′} 〉 ) = {\sum }_{i = 1}^{2 k + 3} {N}_{i} \times {v}_{i} \times {v}_{i}^{′} \qquad [ Equation 9 ]$$

In Equation 9, each of N₁, . . . , N₂ₖ₊₃ represents a weight for each feature vector. The weight may be determined by the designer or the user and may be used to emphasize a relatively important portion in determining a function. For example, when determining presence or absence of a payable keyword is determined to be important for the function in computing the probability, the weight may be determined to establish N₁, . . . N₂ₖ<N₂ₖ₊₁,N₂ₖ₊₂,N₂ₖ₊₃. Meanwhile, when transforming a given transaction sequence to a word sequence, the pseudo-start word<s> is appended at the beginning of the word sequence. The pseudo-end word<e>may not be appended. This is to determine whether further exploration of a given transaction sequence, instead of determining whether the given transaction sequence itself is vulnerable, is helpful in finding a vulnerable sequence when the transaction sequence is given. In this case, according to an example embodiment, the second cost function may be defined as the following Equation 10.

$$cost ( {t}_{0} , … , {t}_{n} ) = - {\prod }_{i = 0}^{n} P ( {w}_{i} \vert {w}_{i - 2} {w}_{i - 1} ) \qquad [ Equation 10 ]$$

In Equation 10, wᵢ₋₁=wᵢ₋₂=<s> and wⱼ may be given as wⱼ=α′_{τ}(tⱼ) if j∈[0,n]. In the aforementioned cost function-based vulnerable transaction sequence candidate selecting process (123), a candidate with least cost is preferentially retrieved for efficiency of search. Therefore, a negative probability is computed using Equation 10.

According to an example embodiment, for generalization of an unknown context, a smoothing method may be further used to determine the second cost function. For example, the smoothing method called simple linear interpolation may be used. The simple linear interpolation refers to a method of appropriately mixing a statistical model for each of 1-gram if n=1, 2-gram if n=2, and 3-gram if n=3 in the n-gram language model. In the case of using the simple linear interpolation, a probability P of Equation 10 may be given as the following Equation 11.

P(wᵢ|wᵢ₋₂wᵢ₋₁)=λ₁P_{add-k}(wᵢ|wᵢ₋₂wᵢ₋₁)+λ₂P_{add-k}(wᵢ|wᵢ₋₁+λ₃P(wᵢ). [Equation 11]

Here, since a sum of all the result values for the probability P needs to be 1

$$( i . e . , {\sum }_{{w}_{j} ∈ V} P ( {w}_{j} \vert {w}_{i - 2} {w}_{i - 1} ) = 1 ) ,$$

a sum of weights λ₁, λ₂, and λ₃ of the language model is likewise 1. Meanwhile, when computing a probability if n=2 or 3 (i.e., a 2-gram model or a 3-gram model), an add-k smoothing method may be used to avoid zero counts in a denominator. The add-k smoothing method refers to a method of preventing the divisor from becoming zero by adding k greater than zero less than 1 to the entire data. In this case, the probabilities P for the 2-gram model and the 3-gram model may be given as the following Equation 12 and Equation 13, respectively.

$${P}_{add - k} ( {w}_{i} \vert {w}_{j - 1} ) = \frac{Count ( {w}_{i - 1} {w}_{i} ) + k}{Count ( {w}_{i - 1} ) + k V} \qquad [ Equation 12 ]$$

$${P}_{add - k} ( {w}_{i} \vert {w}_{i - 2} {w}_{i - 1} ) = \frac{Count ( {w}_{i - 2} {w}_{i - 1} {w}_{i} ) + k}{Count ( {w}_{i - 2} {w}_{i - 1} ) + k V} \qquad [ Equation 13 ]$$

Meanwhile, if n=1, i.e., in the case of using a 1-gram model, the dividend and the divisor may not be zeros and the smoothing method may not be used. In this case, the probability P for the 1-gram model may be given as the following Equation 14.

$$P ( {w}_{i} ) = \frac{Count ( {w}_{i} )}{{\sum }_{{w}_{j} ∈ V} Count ( {w}_{j} )} \qquad [ Equation 14 ]$$

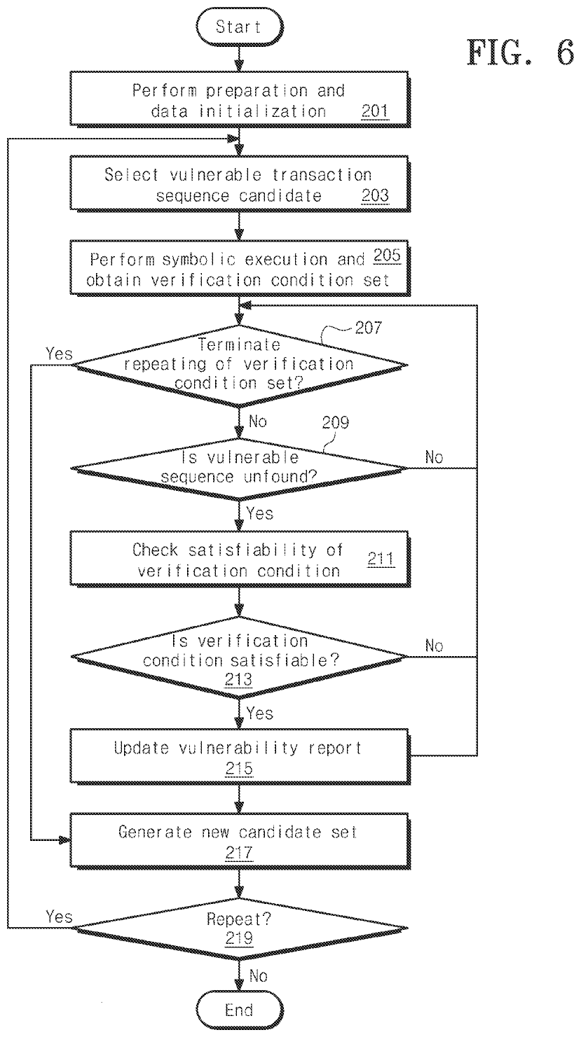

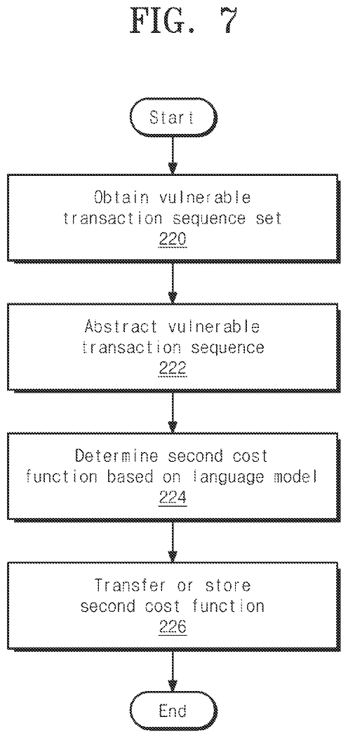

Hereinafter, various example embodiments of a vulnerable transaction sequence obtaining method are described with reference to FIGS. 6 and 7.

FIG. 6 is a flowchart illustrating a vulnerable transaction sequence obtaining method according to an example embodiment.

According to the example embodiment of FIG. 6, a preparation process and a data initialization process for at least one target program to obtain a vulnerable transaction sequence are performed in parallel or sequentially (201). The preparation process may include a process of unrolling at least one loop and/or inlining functions to be called in a target program. Also, the preparation process may include a process of collecting a function path corresponding to each function present in the target program. Here, the target program may be unrolled and/or inlined. The data initialization process refers to a process of initializing data (set) required for a vulnerable transaction sequence processing process. For example, a vulnerability report or a set (workset) for a vulnerable transaction sequence candidate set may be initialized. Depending on example embodiments, at least one of the preparation process and the data initialization process may be omitted.

In a sequential manner, a vulnerable transaction sequence candidate may be selected (203). Selecting of the vulnerable transaction sequence candidate may be performed using at least one cost function. For example, the term “cost function” may be a function defined such that the selected vulnerable transaction sequence candidate may minimize cost. At least one cost function may include at least one of a first cost function and a second cost function. The first cost function may be configured to select a vulnerable transaction sequence with a relatively short length as a candidate. The second cost function may be obtained based on a language model. The second cost function may be obtained by a learning performing process of FIG. 7, which is described below.

Once the vulnerable transaction sequence candidate is selected, symbolic execution for the vulnerable transaction sequence candidate may be performed and at least one verification condition may be obtained accordingly (205). Depending on example embodiments, if the number of verification conditions is plural, a verification condition set may be obtained. To obtain the verification condition, a predetermined verification condition generating function (GenerateVC(s) of FIG. 4) may be used as an example of the symbolic execution. The verification condition generating function is configured to receive a pair of an assertion label and a verification condition for a transaction sequence and to output a predetermined set accordingly. The verification condition generating function may be implemented using, for example, a symbolic executor for the transaction sequence and the symbolic executor for the transaction sequence may be obtained by modifying a symbolic executor for a sequence.

In response to obtaining the verification condition, verification of the verification condition may be performed. Verification for each element (verification condition) of a verification condition set may be performed and, to this end, whether to terminate repeating of the verification condition set may be determined (207). That is, when verification for all the verification conditions is performed (yes of 207), operation 217 may be performed and otherwise (no of 207), verification for each verification condition may be performed. In this case, verification may be performed for a pair of at least one assertion label and verification condition corresponding thereto. Depending on example embodiments, simplification of the verification condition may be further performed before performing the verification. Simplification of the verification condition may be performed based on a predetermined simplification rule. For example, simplification of the verification condition may be performed by excluding logical formulas irrelevant to verification from the verification condition and/or through quantifier elimination optimization.

Whether the vulnerable transaction sequence is found or unfound may be determined depending on verification performance (209). If the vulnerable transaction sequence is unfound (yes of 209), satisfiability of the verification condition may be checked (211). The satisfiability of the verification condition may be checked using at least one analysis program. Here, the at least one analysis program may include, for example, an SMT solver. On the contrary, if the vulnerable transaction sequence is found (no of 209), the following process (211 to 215) such as determining the satisfiability of the verification condition to updating the vulnerability report is not performed. In this case, operation 207 may be performed again to verify an unverified verification condition.

If the verification condition is satisfiable as a result of checking the satisfiability of the verification condition using the SMT solver (yes of 213) (i.e., if a vulnerability revealing case is present in the vulnerable transaction sequence candidate being analyzed), the initialized or updated vulnerability report may be updated accordingly (215). Updating of the vulnerability report may be performed by mapping the transaction sequence determined to be vulnerable to an assertion label and a satisfying model for the verification condition. On the contrary, if the verification condition is not satisfiable (no of 213), updating of the vulnerability report (215) may not be performed and operation 207 may be performed again. Also, after the vulnerability report is updated, operation 207 may be performed again.

When verification for all the verification conditions is performed in operation 207, a new vulnerable transaction sequence candidate set may be generated and the generated vulnerable transaction sequence candidate set may be added to the workset (217). In this case, generating of the new vulnerable transaction sequence candidate set may be performed by adding a new transaction to a current vulnerable transaction sequence candidate set.

The aforementioned process (203 to 217) may be repeated at least once. The aforementioned process (203 to 217) may be repeated until a predetermined condition is met. For example, repeating of the aforementioned process (203 to 217) may be terminated if no vulnerable transaction sequence candidate set is present in the workset, if a vulnerable transaction sequence for all the assert statements is found, and/or if a predetermined time expires.

Hereinafter, a process of obtaining the aforementioned second cost function is described.

FIG. 7 is a flowchart illustrating a process of learning based on a language model according to an example embodiment.

According to an example embodiment of a process of obtaining a second cost function by performing learning based on the language model of FIG. 7, a set of vulnerable transaction sequences is initially obtained (220). The vulnerable transaction sequences in the set may include the vulnerable transaction sequence candidate determined to be vulnerable through the process of FIG. 6. The vulnerable transaction sequence in the set may be obtained by an apparatus that performs learning based on the language model, and/or may be obtained by an external apparatus.

The vulnerable transaction sequence in the set may be abstracted to an appropriate form and the abstracted vulnerable transaction sequence may be obtained accordingly (222). The aforementioned Equation 6 and Equation 7 may be used to obtain the abstracted vulnerable transaction sequence.

When a set of the abstracted transaction sequences is obtained, the second cost function may be determined based on the set of abstracted transaction sequences and the language model (224). Here, the language model may include a statistical language model and more particularly, may include an n-gram language model. In this case, the second cost function may be determined using the aforementioned Equation 10 to Equation 14.

The second cost function may be transferred to a physical device or a logical portion that detects a current vulnerable transaction sequence, or may be stored in a storage to be used by a processor of a vulnerable transaction sequence obtaining apparatus (226).

The aforementioned method for obtaining a vulnerable transaction sequence in a smart contract according to example embodiments may be implemented in a form of a program executable by a computer apparatus. Here, the program may include, alone or in combination, a program instruction, a data file, and a data structure. The program may be specially designed to implement the aforementioned method for obtaining a vulnerable transaction sequence in a smart contract or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method for obtaining a vulnerable transaction sequence in a smart contract may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method for obtaining a vulnerable transaction sequence in a program are described, the apparatus and method for obtaining a vulnerable transaction sequence in a program are not limited to the aforementioned example embodiments. Various apparatuses or methods implementable in such a manner that one of ordinary skill in the art makes modifications and alterations based on the aforementioned example embodiments may be an example of the aforementioned apparatus and method for obtaining a vulnerable transaction sequence in a program. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method for obtaining a vulnerable transaction sequence in a program.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A method of obtaining a vulnerable transaction sequence, the method comprising:
selecting a vulnerable transaction sequence candidate in at least one program using a cost function;
obtaining a verification condition by performing symbolic execution over the transaction sequence candidate; and
checking whether the verification condition is satisfiable when the vulnerable transaction sequence is unfound as a verification result about the verification condition, and determining the vulnerable transaction sequence candidate as the vulnerable transaction sequence when the verification condition is satisfiable.

2. The method of claim 1, further comprising:
obtaining the cost function,
wherein the obtaining of the cost function comprises:
obtaining a set of vulnerable transaction sequences;
abstracting a vulnerable transaction sequence in the set of vulnerable transaction sequences; and
determining the cost function using the abstracted vulnerable transaction sequence and a language model.

3. The method of claim 1, further comprising:
simplifying the verification condition when the verification condition is obtained.

4. The method of claim 3, wherein the simplifying of the verification condition comprises at least one of:
excluding logical formulas irrelevant to verification from the verification condition; and
performing quantifier elimination optimization.

5. The method of claim 1, further comprising:
unrolling a loop in the at least one program or inlining a function to be called at each call site in the at least one program.

6. The method of claim 1, wherein the at least one program comprises a smart contract.

7. The method of claim 1, wherein the obtaining of the verification condition by performing the symbolic execution over the transaction sequence candidate comprises obtaining the verification condition using a verification condition generating function for the transaction sequence candidate, and
the verification condition generating function uses a symbolic executor for a transaction sequence based on a symbolic executor for a transaction.

8. An apparatus for obtaining a vulnerable transaction sequence, the apparatus comprising:
a storage configured to transitorily or non-transitorily store at least one program; and
a processor configured to receive the at least one program, to select a vulnerable transaction sequence candidate in the at least one program using a cost function, to obtain a verification condition by performing symbolic execution over the transaction sequence candidate, and to check whether the verification condition is satisfiable when the vulnerable transaction sequence is unfound as a verification result about the verification condition, and to determine the vulnerable transaction sequence candidate as the vulnerable transaction sequence when the verification condition is satisfiable.

9. The apparatus of claim 8, wherein the processor is configured to obtain a set of vulnerable transaction sequences, to abstract a vulnerable transaction sequence in the set of vulnerable transaction sequences, and to determine the cost function using the abstracted vulnerable transaction sequence and a language model.

10. The apparatus of claim 8, wherein the processor is configured to simplify the verification condition when the verification condition is obtained.

11. The apparatus of claim 10, wherein the processor is configured to simplify the verification condition by performing at least one of exclusion of logical formulas irrelevant to verification from the verification condition and quantifier elimination optimization.

12. The apparatus of claim 8, wherein the processor is configured to unroll a loop in the at least one program or inline a function to be called at each call site in the at least one program.

13. The apparatus of claim 8, wherein the at least one program comprises a smart contract.

14. The apparatus of claim 8, wherein the processor is configured to obtain the verification condition using a verification condition generating function for the transaction sequence candidate, and
the verification condition generating function uses a symbolic executor for a transaction sequence based on a symbolic executor for a transaction.
